(19) United States
(12) Patent Application Publication
(10) Pub. No.: US 2006/0029200 A1
(43) Pub. Date: Feb. 9, 2006

(54) Method and system for improved travel transaction billing and reconciling

(76) Inventors: Sarah Tasker, Brighton (GB); Olivier Sauser, Jouars Ponchartrain (FR); Steve Preston, Brighton (GB); John Ward-Caddle, Westdene (GB); Alan Holmes, Hove (GB); Val Moore, Eastbourne (GB); Joy Lamb, Hove (GB)

Correspondence Address: FITZPATRICK CELLA HARPER & SCINTO, 30 ROCKEFELLER PLAZA, NEW YORK, NY, 10112, US

(21) Appl. No.: 11/042,663

(22) Filed: Jan. 24, 2005

Related U.S. Application Data
(60) Provisional application No. 60/599,353, filed on Aug. 6, 2004.

(51) Int. Cl. H04M 15/00

(52) U.S. Cl. 379/126; 379/114.14

(57) ABSTRACT

There is provided a method and system for improved travel transaction billing and reconciling that permits a financial services provider to generate a centralized, detailed and customized billing statement based on travel itinerary data and information received from a travel agent or agency for travel transactions booked during a billing period, which can permit expedited generation and submission of the billing statement at the end of a billing period to a responsible client for faster payment of billed transactions. The financial services provider does not wait for receipt of travel supplier charges before generating the billing statement for travel transactions based on received travel agent records. The financial services provider can subsequently reconcile, unique reference indicator, the billing statement travel transactions or travel itinerary data against travel supplier charges received from the travel supplier for the booked travel transactions.

### CROSS REFERENCE TO RELATED APPLICATIONS

The present application claims the benefit of U.S. Provisional Patent Application Ser. No. 60/599,353, filed Aug. 6, 2004 and titled “Method and System for Improved Travel Transaction Billing and Reconciling”.

### TECHNICAL FIELD

The present subject matter relates to travel related transactions. More specifically, to systems and methods for centralized billing and reconciliation processes relating to travel transactions.

### BACKGROUND

Business travel account products are centrally billed cardless accounts provided by financial services providers and typically set up with travel agents or agencies for use by companies to charge, monitor and track travel of employees, designated individuals or groups of people conducting company business. A business travel account enables employee travelers to book and charge travel related expenses, such as air and rail expenses, in the course of their employment.

In existing business travel account systems and processes, users typically interact with a travel agent or agency to book travel transactions. The company employee or user contacts the travel agent or agency to book travel transactions using the company's business travel account as payment. The travel agent then books the requested travel with a travel supplier. In existing business travel accounts, a financial services provider typically generates and issues a billing statement for booked travel itineraries to a customer based on information and data received from the travel supplier and travel agent. The travel supplier submits a travel supplier charge file requesting payment for booked travel transactions and the travel agent submits a travel agent travel itinerary file which includes the travel itinerary and associated travel agent costs, e.g., travel agent commission. The billing statement is typically generated after both the travel supplier charge file and travel agent itinerary file are received and matched. The financial services provider generates a billing statement that is based on the travel supplier charge file augmented by a corresponding and matching travel supplier charge file. The corporate customer then receives a billing statement having detailed information about all travel related transactions charged to a business travel account number and matched during a billing period.

Existing business travel account systems and processes suffer from drawbacks that can make them ineffective and inefficient. Often, travel supplier charge file and travel agent travel itinerary files are not synchronized, and are not generated and submitted to the financial services provider at the same time. This lack of synchronization in receiving the travel supplier charge files and travel agent travel itinerary files can be problematic if the end of a billing period arrives and both the travel supplier charge file and travel agent travel itinerary file have not been received by the financial services provider. The financial services provider may only be able to generate a billing statement having the travel agent travel itinerary file which has a matching travel supplier charges file. This can result in incomplete information and unposted or unbilled travel transactions on the billing statement at the end of the billing period.

If the travel supplier has not received both a travel supplier charge file or a travel agent travel itinerary file by the end of the billing period, the financial services supplier may be forced to generate a billing statement that lacks complete travel itinerary details and/or travel supplier charges. If the billing statement lacks detailed and complete information about the billed travel transactions, the customer may delay payment of the billing statement while the customer confirms the billed travel transactions. Also, a financial service provider may need to carry over open travel transactions to the next billing period until matching travel agent itinerary files and travel supplier charges are received that will permit detailed information on the billing statement. This can negatively impact the financial services provider's cash flow position since the financial services provider must typically settle travel supplier charges with the travel supplier upon receipt of the travel supplier charge file regardless of whether a billing statement has been issued to a customer or whether a travel agent travel itinerary has also been received.

There is thus a need for a system and method for a financial services provider to provide a detailed and customized billing statement for booked travel transactions during a billing period that enables expedited payment and reconciliation of the travel transactions.

### SUMMARY

There is provided a system and method for a financial services provider to generate a centralized, detailed and customized billing statement based on travel itinerary data and information received from a travel agent or agency for travel transactions booked during a billing period. The generation of the billing statement based on received travel agent information or data advantageously permits a financial service provider to expedite the generation and submission of the billing statement at the end of a billing period to a responsible company client or customer, which can result in expedited payment of the billed transactions by the responsible customer. The financial services provider can generate a billing statement for transactions based on a travel agent record or data file instead of a travel supplier charge, and does not have to wait for receipt of both the travel supplier charge data and travel agent data.

There is provided a standalone computer-readable medium, such as a server, mainframe or other computer platform, having computer-executable instructions for billing one or more travel transactions which enable the performance of a) receiving a first data file, having a reference indicator, from a first source; b) generating a billing statement based on the received first data file; and c) sending the billing statement to a customer. There is further included the steps of d) receiving a second data file, including the reference indicator, from a second source; e) reconciling the first data file and the second data file using the reference indicator; and f) generating a revised billing statement if the first and second data files are unmatched.

There is also provided a method for booking and billing travel related transactions including the steps of a) creating a travel transaction request at a first server; b) transmitting the travel transaction request to a second server; c) generating, at the second server, a reference indicator in response to the travel transaction request; d) transmitting the reference indicator to the first server to confirm the travel transaction request; e) transmitting a first data file, including the reference indicator, to a billing server or platform; f) generating a billing statement for a billing period based on the first data file; and g) sending the billing statement to a customer. The method can further include the steps of h) generating a second data file, having the reference indicator, at the second server corresponding to the travel transaction request; i) transmitting the second data file to the third server; j) reconciling the first data file with the second data file using the reference indicator; and k) generating a revised billing statement if the first and second data files are unmatched.

It is an objective to provide a system and process where a financial services provider can expedite the generation of a billing statement through the use of travel data files received from a travel agent or travel agency for booked travel transactions.

It is another objective to provide a system and process where a financial services provider can expedite the generation of a billing statement based on travel itinerary data files for booked travel transactions for faster payment of billed travel transactions resulting in improved cash flow for the financial services provider.

It is also an objective to provide a process and standalone account receivable system for centrally billing a customer directly from a travel agent's invoice record or travel itinerary for booked travel transactions.

It is an objective to provide a process and standalone account receivable system that permits accounting reconciliation of travel transactions billed to a client, based on a travel agent's invoice record or travel itinerary, with corresponding travel supplier charges submitted by a travel supplier.

It is further an objective to provide a process and standalone account receivable system that provides a client or customer with a consolidated and customized billing statement incorporating client specific data to enable centralized payment of travel expenses and transactions.

It is an objective to provide a process and standalone account receivable system that enables a client or customer to centrally receive and pay billing statements for travel expenses having customized detailed management information on the billing statement.

It is also an objective to provide a process and standalone account receivable system for generating a billing statement that accurately reflects travel transactions booked during a billing period along with complete travel agent transaction data instead of waiting to receive a travel supplier charge record of file.

It is further an objective to provide a process and standalone account receivable system for expediting the generation of a billing statement for faster payment to the financial services provider of the billed transactions, which results in improved float position for the financial services provider since travel transactions can be billed to the client before the travel supplier has submitted a travel supplier charge to the financial services provider for payment.

Additional objects, benefits, advantages and novel features of the subject matter will be set forth in part in the description which follows, and in part will become apparent to those of ordinary skill in the art upon examination of the following drawings, or may be learned by practice, production or operation of the subject matter. The objects and advantages of the concepts and subject matter may be realized and attained by means of the methodologies, instrumentalities and combinations particularly pointed out in the appended claims.

### BRIEF DESCRIPTION OF THE DRAWINGS

The drawings and figures depict one or more implementations in accord with the present concepts and subject matter, by way of example only, not by way of limitation. In the figures, like reference numerals refer to the same or similar elements. The present subject matter and description may be better understood when read in connection with the accompanying drawings, figures or diagrams, of which:

FIG. 1 illustrates a system that can implement a billing and reconciling process for travel transactions according to one aspect of the present subject matter;

FIG. 2 illustrates an application flow for a billing and reconciling process for travel transactions according to one aspect of the present subject matter;

FIG. 3 illustrates an application process flow for billing and reconciling travel transactions involving an air travel supplier according to one aspect of the present subject matter;

FIG. 4 illustrates an application process flow for billing and reconciling travel transactions involving a non-air travel supplier according to one aspect of the present subject matter;

FIGS. 5A and 5B illustrate a process for billing and reconciling travel transactions according to one aspect of the present subject matter.

### DETAILED DESCRIPTION

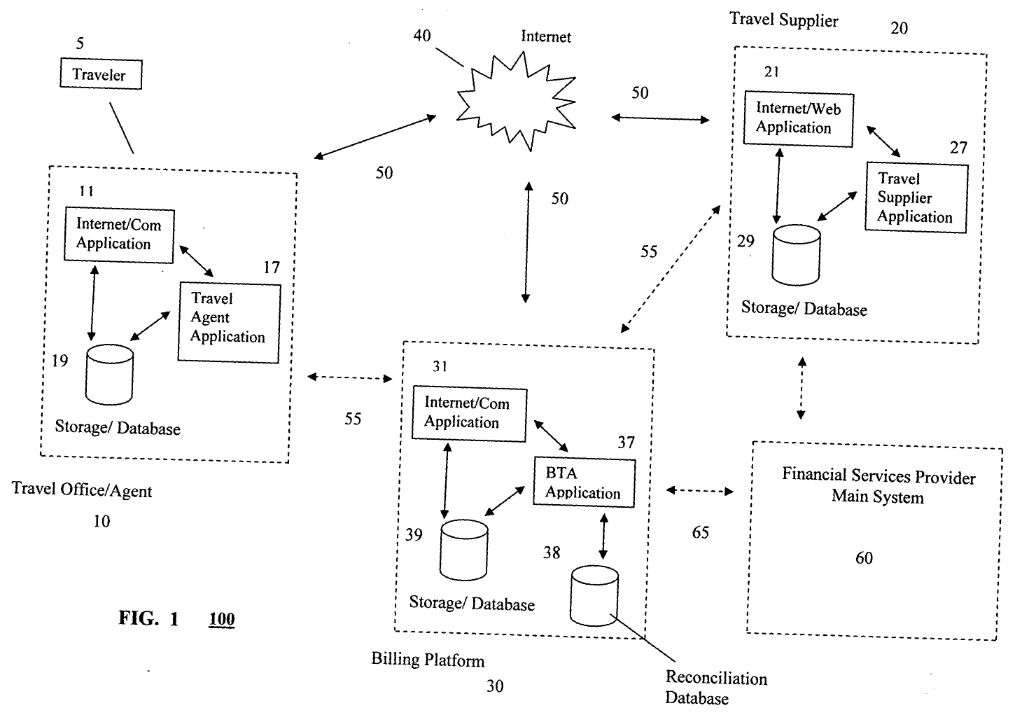

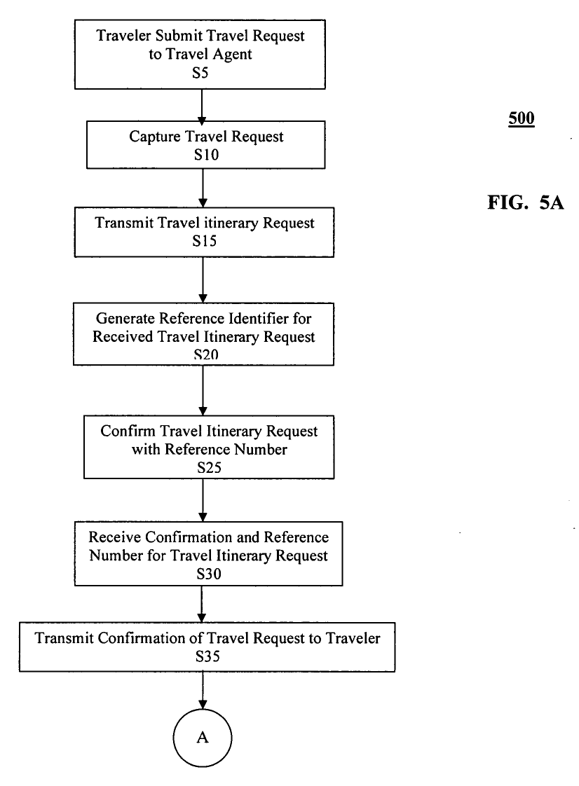

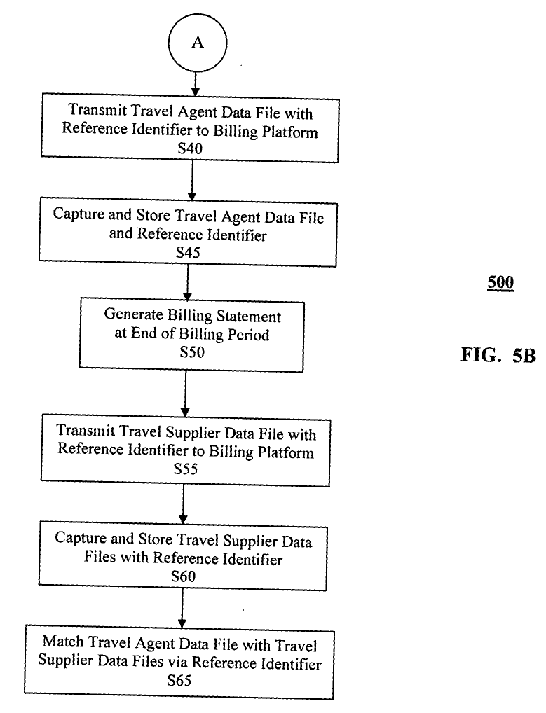

FIGS. 1-4 illustrate a block diagram of an overall system 100 and application process flow 200, 300 and 400 that can be used to implement an improved billing and reconciling process 500, shown in FIGS. 5A-5B, for travel transactions according to one aspect of the present subject matter. Generally, the overall system 100, 200, 300 and 400 can include a traveler 5 or responsible customer, such as, for example, a customer administrator 205, a travel agent 10, one or more travel suppliers 20, a standalone billing and reconciliation platform 30, a financial service provider 60, internet communications links 50 and direct communications links 55 for the transmission of data. As understood in the context of the system 100, 200, 300 and 400 and process 500, the travel agent 10 may be a travel agency office or travel agency computer or network. Similarly, the travel suppliers 20 may be one or more travel supplier computers or networks and the financial service provider 60 may be a financial service provider network or system. The system and process 100, 200, 300, 400 and 500 for an improved travel transaction billing and reconciling permits a financial services provider 60 to generate a centralized, detailed and customized billing statement based on or driven by travel itinerary data and information received from a travel agent 10 for travel transactions booked during a billing period. The generation of the billing statement based on received travel agent information or data advantageously permits a financial service provider 60, via the billing platform 30, to expedite the generation and submission of the billing statement at the end of a billing period to the traveler 5, which can result in expedited payment of the billed transactions by the traveler 5.

The traveler 5, or other designated individual, contacts travel agent 10 in order to book a travel transaction that will be billed to a company business travel account previously set up by the financial services provider 60 and the traveler's 5 company or employer. The traveler 5 is an authorized individual that can contact the travel agent 10 to submit travel or booking requests. The traveler 5 can be an individual authorized to submit travel or booking request, such as an employee, company administrator, termed customer or other responsible customer. The traveler 5 can contact the travel agent 10 by any of various known means, including visiting the travel agent in person, or through a telephone, a facsimile or user computer (not shown) connected to the travel agent 10. The travel agent 10 in the system and process 100, 200, 300, 400 and 500 can have one or more machines that run or execute one or more software applications, including a web interface application 11 and the business travel account software application 17 that permit the travel office to communicate with one or more travel suppliers 20, the billing platform 30 and the financial services provider 60.

The traveler 5 can provide a traveler profile or customer specific information that identifies the traveler and company to the travel agent 10. The information submitted by the traveler 5 can include name of traveler, the traveler's company cost center, project code, etc. The amount and type of data and information provided by the traveler 5 to the travel agent 10 preferably includes all information and data that was previously defined and agreed to as necessary or desired by the business travel account company and the financial services provider 60. The amount and type of information collected will vary according to the specific needs of the company and financial services provider 60.

The travel agent 10 can access a business travel account number that corresponds to information submitted by the traveler 5 in order to correlate any travel request to the accessed business travel account number. The accessed account number may or may not be displayed or shared with the traveler 5 depending on the arrangement between the company and the financial services provider 60.

The travel agent 10 is able to receive and capture the traveler's 5 desired travel or booking request. In one aspect, the travel agent 10 can create the traveler's 5 travel request via the business travel account software application 17 which may be loaded on a computer or network machine operated by the travel agent 10. The travel agent 10 will enter the traveler's travel request which includes desired traveling information, such as place of travel origin and travel destination, dates of travel and selection of a desired travel supplier, e.g., an airline or non-airline merchant. The business travel account software application 17 can capture the booking or travel request entered by the travel agent 10 and store the booking or travel request in an associated travel office storage medium such as a database 19.

The travel agent 10 can then submit a travel itinerary or booking request, which includes the travel request, to the one or more travel suppliers 20, e.g., an airline or a railroad company, for booking and confirmation of the travel itinerary request. The business travel account software application 17 can transmit the travel itinerary request to a selected one of the one or more travel suppliers 20, e.g., an airline or railroad network. The travel agent 10 can communicate with the travel supplier 20 via an internet communication link 50 using an internet application 11 or can communicate directly using a dedicated communication link (not shown). Those of ordinary skill in the art will readily recognize that other known communication means may be used, instead of or in conjunction with the internet communication link 50. The business travel account software application 17 is adapted to receive a confirmation and a unique reference number or identifier from the travel supplier 20 for the travel itinerary request. The business travel account software application 17 can store the received booking confirmation and unique reference number or identifier in its associated database 19. The travel agent 10 can then provide the received confirmation for the booked travel request to the traveler 5 who submitted the travel request.

The travel agent 10 is also adapted to generate a travel itinerary, including the unique reference number or indicator, for transmission to the standalone billing platform 30 of the financial services provider 60. The travel agent 10 can communicate with the billing platform 30 via an internet communication link 50 using a web application 11 or can communicate directly using a dedicated communication link 55. Those of ordinary skill in the art will readily recognize that other known communication means may instead or additionally be used. For example, the travel agent 10 can also transmit the travel itinerary to the billing platform 30 through the larger financial services provider 60 connected 65 to the billing platform 30.

The booked travel itinerary submitted by the travel agent 10 includes data and information that will be included in the billing statement generated by a billing platform 30. The travel itinerary preferably includes data and information previously agreed to by the customer and financial services provider 60 for inclusion in a billing statement. The travel itinerary can include the traveler's name, the traveler's company cost center, project code, invoice number, travel agent commission, etc. Further, the travel itinerary submitted preferably includes the unique reference number or identifier received from the travel supplier 20 for the travel itinerary request. The unique reference number or identifier along with other booking travel details enables the billing platform 30 to properly track, bill and store booked travel itinerary transactions and to reconcile travel suppliers charges for the booked travel itinerary requests.

The travel supplier 20 in the system and process 100, 200, 300, 400 and 500 can have one or more machines that run or execute one or more software applications, including a web interface application 21 and a travel supplier business travel account application 27. The travel supplier application 27 is adapted to receive the booking request or travel itinerary request transmitted by the travel agent 10 for booking and confirmation. Those of ordinary skill in the art will readily recognize that there can be more than one travel supplier 20 providing travel services in the system and process 100, 200, 300, 400 and 500. The travel supplier 20 can communicate with the travel agent 10 and the billing platform 30 via an internet communication link 50 using a web application 21 or can communicate directly using a dedicated communication link 55. Those of ordinary skill in the art will readily recognize that other known communication means may instead or additionally be used. For example, the travel supplier 20 can also transmit communicate data and information to the billing platform 30 through the larger financial services provider 60 connected 65 to the billing platform 30.

The travel supplier application 27 is adapted to receive the travel itinerary request transmitted by the travel agent 10. The travel supplier application 27 can confirm the travel itinerary request and generate a unique identifier or reference number for the received travel itinerary request. The travel supplier application 27 then transmits a confirmation and the unique identifier or reference number to the travel agent 10. The travel supplier application 27 also stores the confirmation, unique reference number and the received travel itinerary request in its associated travel supplier database storage 29. In this manner, the travel supplier 20 can may subsequently access and transmit this information as needed.

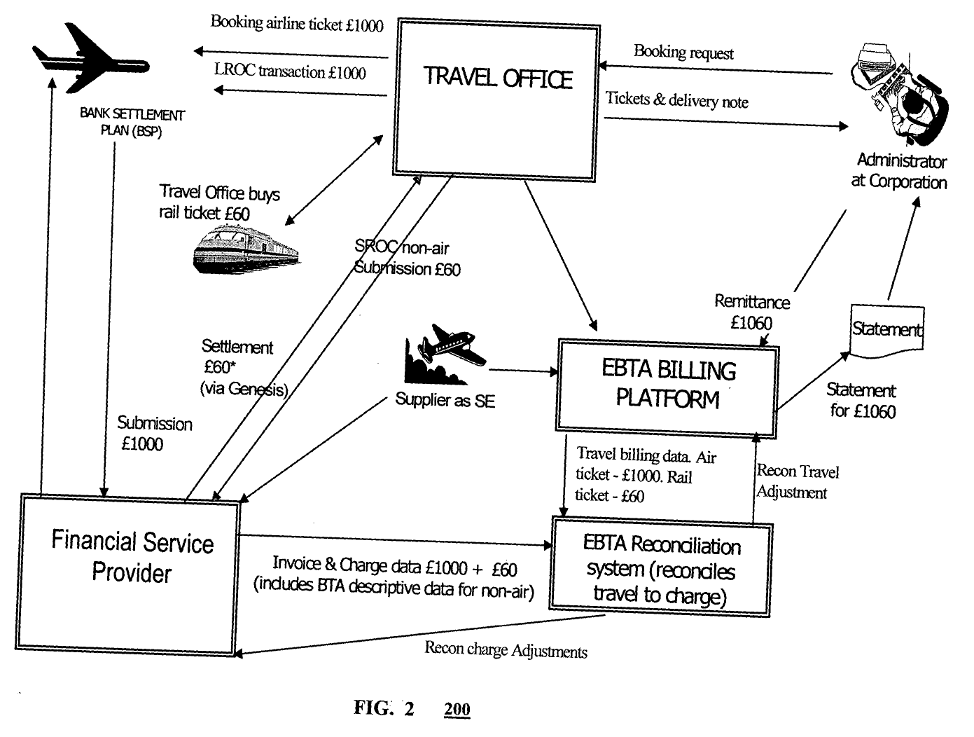

The travel supplier 20, via its software application 27, is also adapted to generate a travel supplier charge file, which includes travel supplier charges for a confirmed travel itinerary request, as shown in FIG. 2. The travel supplier 27 can then transmit the travel supplier charge file to the billing platform 30 for use in reconciling corresponding travel transactions included in a billing statement. The travel supplier 20 can transmit the travel supplier charge file directly to the billing platform 30 or through the financial services provider 60 connected 65 to the billing platform 30. In some cases, a travel supplier 20 may not submit a travel supplier charge file until after the traveler 5 has actually used the services provided by the travel supplier 20.

The travel supplier charge file can include data and information requested or required by the financial services provide 30 to settle the travel supplier's travel transaction charges. For example, the travel supplier charge file can include data and information about the confirmed travel itinerary request such as billing and pricing data, traveler's name, traveler's company and cost center information, travel dates and times, etc. In a preferred aspect, the travel supplier charge file will include the generated unique reference number or identifier. The unique reference number or identifier enables the billing platform 30 to properly reconcile the travel supplier charge file to a corresponding travel office itinerary received from the travel agent 10 and included in billing statements previously generated and sent to responsible companies.

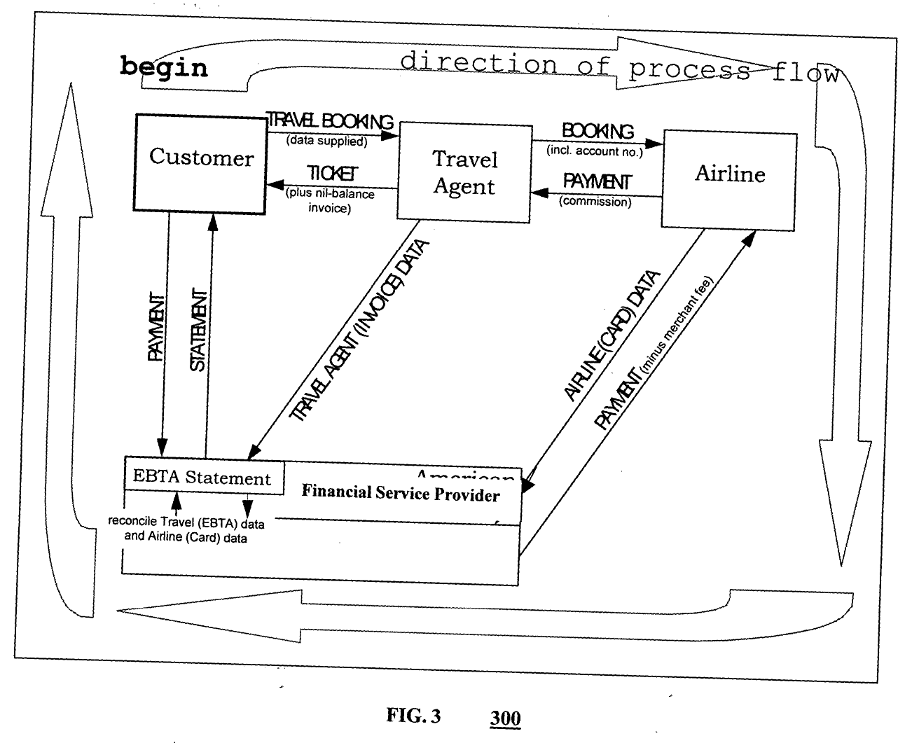

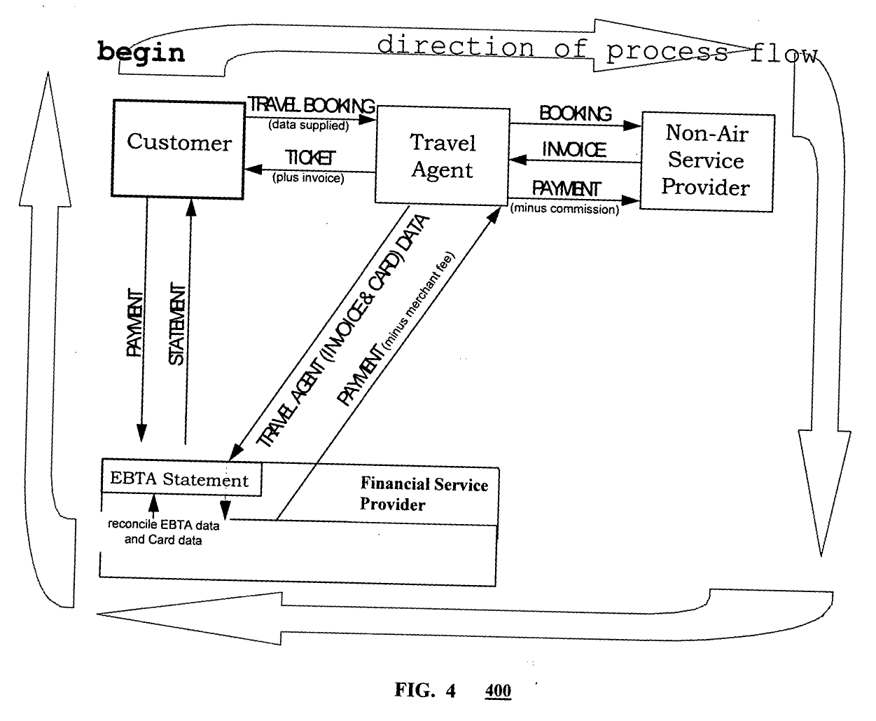

The billing platform 30, shown in FIGS. 1-4 is preferably a apparatus or component with one or more machines or servers running and executing software applications, including a web interface application 31 and a business travel account billing application 37 and reconciliation application 38. The billing platform 30 is preferably a standalone apparatus that can perform its functions, e.g., billing and reconciliation, independent of an associated financial services provider 60, as shown in FIGS. 1 and 2. Those of ordinary skill in the art will readily recognize that the billing platform 30 can be connected or associated with the financial services provider 60, as shown in FIGS. 3 and 4, to take advantage of existing infrastructure in the financial services provider 60. For example, to take advantage of communications infrastructure that enables the financial services provider 60 to receive data and information from the travel agent 10 and the travel supplier 20.

The billing platform 30, via communication links 50, 55 and 65 and the business travel application 37, is adapted to receive data files from the travel agent 10, and the travel supplier 20, and from the main financial services provider 60. The billing platform 30 can store received data files in an associated provider database 39 or reconciliation database 38 where they are subsequently accessible as needed for billing, reconciling, reporting and other billing platform functions.

The billing platform 30 can communicate with the travel agent 10, travel supplier 20 and the main financial services provider 60 via an internet communication link 50, though dedicated and direct communication links 55 may instead or additionally be used. The billing platform 30 can communicate with the travel agent 10 and the travel supplier 20 via an internet communication link 50 using a web application 31 or can communicate directly using a dedicated communication link 55. The billing platform 30 may also communicate directly with the main financial service provider 60 using a dedicated communication link 55 when data and information is sent to the billing platform 30 through the larger financial services provider 60 connected 65 to the billing platform 30. Those of ordinary skill in the art will readily recognize that other known communication means may instead or additionally be used.

The billing platform 30 is adapted to receive data and information files from the travel agent 10 and travel supplier 20 relating to booked travel transactions. The received data and information files from the travel agent 10 and travel supplier 20 will each contain the unique reference number or indicator generated during confirmation and booking of the travel itinerary request. The billing platform 30, via its business travel account application 37 and reconciliation apparatus 38 is adapted to carry out and execute various functions and capabilities, including tracking, storing, billing and reconciling of booked travel itinerary or travel related transactions. The data files received provide a means for the billing platform 30 to generate billing statements based on the data files received from the travel agent 10 and to reconcile the billed travel transactions using the travel supplier data files.

In a preferred aspect, the billing platform 30 receives the travel itinerary data files from the travel agent 10 prior to receiving travel supplier charges corresponding to the received travel itinerary files. The billing platform 30 is adapted to generate a billing statement based on the travel itinerary data files received from the travel agent 10. The generation of the billing statement is thus driven by the received travel itineraries from the travel agent 10. The billing platform 30 does not have to wait for receipt of both the travel supplier charges and travel agent travel itinerary files. The billing statement can be generated at the end of a billing period, e.g., monthly, weekly, or a defined day of month, etc., for submission to the responsible company for payment of the booked travel transactions.

In this manner, the billing platform 30 can expedite the generation and submission of billing statements for payment by a responsible company without waiting for the travel supplier 20 to submit corresponding travel charge files, which may arrive after the travel agent travel itinerary data, often several days later, before issuing a billing statement. In this manner, the financial services provider 60 can potentially receive payment from the company customer prior to being billed by the travel supplier 20 for their travel supplier services to the traveler 5. Expediting the generation of the billing statement, based on a received travel itinerary, can result in an improved cash flow or float position for the financial services provider 60 when the financial services provider 60 is paid for the billed travel transactions prior to receiving the corresponding travel supplier charges for the previously billed travel transactions.

The financial services provider 60 subsequently reconciles the billing statement generated by the billing platform 30 with travel supplier charges received from the travel supplier 20 for the booked travel transactions. The billing platform 30, via a reconciliation platform or database 38, can reconcile the billed travel transactions in a generated billing statement against travel supplier charges received from the travel supplier 20. The billing platform 30, via the reconciliation database 38, receives travel supplier charge files including the unique reference numbers. The travel supplier charge files typically arrive after the travel itinerary files. Once the travel supplier charge files are received, the billing and reconciliation platform 30 and 38 uses the unique reference numbers to reconcile the previously generated and submitted travel office travel itineraries in the billing statement against the travel supplier charges received from the travel supplier 20.

The unique reference number is used as the means to determine whether the various received data files match or correspond. This aspect allows the billing and reconciliation platform 30 and 38 to ensure that a previously submitted billing statement, which was based on the travel itinerary files, was accurate. If the received data files do not match or correspond, the billing platform 30 or financial services provider 60 can initiate steps to determine where and how the mismatch occurred and, if necessary, initiate generation of a revised billing statement to the affected company.

The ability to generate an expedited billing statement based on the received travel agent travel itinerary can result in improved financial services provider cash flow or float position due to the possibility of receiving the company's payment prior to receiving the travel supplier charges. The system and method for improved travel transaction billing and reconciling can also result in additional capabilities, functions and features, including among others: a single statement for all the customer's business travelers; variable billing statement frequency and date (monthly, fortnightly, weekly, daily, specified day of the month); ability to create “adhoc” statements when required; detailed transaction data; free format reference fields available for customer-specific data; multi-level sorting and subtotaling options on the statement, including page throw by sort type; choice of statement designs available, offering differing fields/formats of transaction data; open item billing—(unpaid transactions continue to be itemized on statement until paid); ability to receive multiple copies to differing addressees; billing and AR/AP (data feed) reconciliation processes separated; a billing statement which can be supplied in electronic format (TMKD) which the client can automatically feed into their general ledger system; delayed payment charges, giving the client the ability to pay the account later than the due date so long as they cover the cost to the financial services provider of funding the debt; market level interest rates for delayed payment charges can be overwritten at business travel account number level; the ability to dispute transactions and temporarily remove them from the ageing process; and payment power software tool available for billing support file manipulation.

FIGS. 5A and 5B show a flowchart for a process 500 for billing an reconciling of travel transactions that can be implemented in the systems shown in FIGS. 1-4 according to one aspect of the present subject matter. The process 500 shown enables a traveler 5 and travel agent 10 to make travel transactions or bookings for desired travel in conjunction with a travel supplier 20. The process 500 also enables a financial services provider billing platform 30 to generate a billing statement for a company based on one or more travel itinerary data files received from the travel agent 10 and to reconcile, via the unique reference number, the billed travel transactions by additionally using travel supplier charge files received from the travel supplier. 20.

In step S5, a traveler 5 submits a desired travel request along with necessary traveler identifying information and company information to the travel agent 10. The desired travel request can include origin and destination cities, travel dates, travel mode, e.g., air, rail or sea, travel supplier desired, etc. The traveler identifying information can include the traveler's name, the traveler's company cost center, project code, etc. The traveler 5 can be an employee or company designated individual authorized to contact the travel agent 10 for booking travel transactions that are billed to the company.

In step S10, the travel agent 10 can capture and store the travel request. The travel agent 10 also accesses a business travel account number that corresponds to information submitted by the traveler 5 in order to correlate any booked travel request to the accessed account number. In step S15, the travel agent 10 can transmit the travel itinerary to an appropriate travel supplier 20, e.g., an airline or a railroad company, for booking and confirmation of the requested travel itinerary.

In step S20, the travel supplier 20 generates a unique reference number or identifier, e.g., unique ticket number, for the received travel itinerary request. In step S25, the travel supplier 20 confirms the travel itinerary request by transmitting the unique reference number to the travel agent 10.

In step S30, the travel agent 10 receives unique reference number as a booking confirmation of the travel itinerary request. In step S35, the travel agent 10 can inform the traveler 5 of the received travel itinerary confirmation.

In step S40, the travel agent 10 can generate a travel itinerary data file, which includes the unique reference number, and transmit it to the billing platform 30. The travel itinerary transmitted to the billing platform 30 includes data and information previously agreed to by the company and financial services provider 60 for inclusion in a billing statement.

In step S45, the billing platform 30 receives and captures the travel itinerary and stores the received travel itinerary in its associated storage medium, such as a designated database 39.

In step S50, the billing platform 30 can generate a billing statement at the end of a billing period. The billing platform 30 preferably generates the billing statement based on the received travel agent travel itinerary data file to thereby expedite the billing process for booked travel transactions. The billing platform 30 does not wait until corresponding travel charge data files are also received from the travel supplier 20. In one specific aspect, the billing statement is generated at the end of a billing period upon receipt of the last travel itinerary on the last day of a billing period.

In step S55, the travel supplier 20 generates travel supplier charge files, having a unique reference number, for booked and confirmed travel itinerary requests, which are then transmitted to the billing platform 30. The travel supplier charge files for a specific travel itinerary can be transmitted to the billing platform 30 at the same time as the corresponding travel itinerary, but are typically reported after the matching travel itinerary is reported and received at the billing platform 30. In step S60, the billing platform 30 captures and stores the travel supplier charge files in an associated storage medium, such as a database or reconciliation database 38.

In step S65, the billing platform 30 access the travel supplier charge files and travel itinerary files for reconciliation of booked travel transactions previously received from the travel agent 10. The travel supplier charge files and travel itinerary files are matched or reconciled using the unique reference number that is included in each data file received from the travel agent 10 or travel supplier 20. In one case, the matching and correlation may be performed in a designated reconciliation database 38. Uncovered discrepancies can be subsequently be corrected. For example in a revised billing statement generated and sent to the company.

Those of ordinary skill in the art will readily recognize that many of the functions and aspects of the system can be implemented on networked computers, which may be connected for data communication via components of a network. The hardware of such computer platforms typically is general purpose in nature, albeit with an appropriate network connection for communication via the intranet, the Internet and/or other data networks

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. The computer system also may be coupled to a display and one or more user input devices such as alphanumeric and other keys of a keyboard, a mouse, a trackball, etc. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or built into routing elements or nodes of the network.

The software functionalities (e.g., many of the operations described above) involve programming of controllers, including executable code as well as associated stored data. The software code is executable by the general-purpose computer that functions as the particular computer. In operation, the executable program code and possibly the associated data are stored within the general-purpose computer platform. At other times, however, the software may be stored at other locations and/or transported for loading into the appropriate general-purpose computer system. Hence, the embodiments involve one or more software products in the form of one or more modules of code carried by at least one machine-readable medium. Execution of such code by a processor of the computer platform enables the platform to implement the system or platform functions, in essentially the manner performed in the embodiments discussed and illustrated herein.

As used herein, terms such as computer, server or machine readable medium refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s). Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the technology and processes disclosed herein may be implemented in various forms and examples, and that they may be applied in numerous applications, only some of which have been described herein. Those skilled in that art will recognize that the disclosed aspects may be altered or amended without departing from the true spirit and scope of the subject matter. It is intended by the following claims to claim any and all modifications and variations that fall within the true scope of the advantageous concepts disclosed herein.

We claim:

1. A computer-readable medium having computer-executable instructions for billing one or more transactions, the computer-executable instructions performing the steps of:
a) receiving a first data file, having a reference indicator, from a first source;
b) generating a billing statement based on said received first data file; and
c) sending said billing statement to a customer.

2. The computer-readable medium of claim 1, further comprising computer-executable instructions for performing the step of:
d) receiving a second data file, including said reference indicator, from a second source; and
e) reconciling said first data file and said second data file using said reference indicator.

3. The computer-readable medium of claim 2, further comprising computer-executable instructions for performing the step of:
f) generating a revised billing statement if said first and second data files are unmatched.

4. The computer-readable medium of claim 1, wherein said first source is a travel office server and said second source is a travel supplier server.

5. The computer-readable medium of claim 1, wherein said first data file is a travel itinerary data file and said second data file is a travel supplier charge file.

6. The computer-readable medium of claim 1, wherein said computer-readable medium is a standalone server or mainframe computer.

7. The computer-readable medium of claim 1, wherein said billing statement comprises selected transaction information requested by said customer.

8. A method for booking and billing transactions, the method comprising the steps of:
a) creating a travel transaction request at a first server;
b) transmitting said travel transaction request to a second server;
c) generating, at said second server, a reference indicator in response to said travel transaction request;
d) transmitting said reference indicator to said first server to confirm said travel transaction request;
e) transmitting a first data file, including said reference indicator, to a third server;
f) generating a billing statement for a billing period based on said first data file; and
g) sending said billing statement to a customer.

9. The method of claim 8, further comprising the steps of:
h) generating a second data file, including said reference indicator, at said second server corresponding to said travel transaction request;
i) transmitting said second data file, including said reference indicator, to said third server and
j) reconciling said first data file with said second data file using said reference indicator.

10. The method of claim 9, further comprising the step of:
k) generating a revised billing statement if said first and second data files are unmatched.

11. The computer-readable medium of claim 8, wherein said first server is a travel office server and said second source is a travel supplier server.

12. The computer-readable medium of claim 8, wherein said first data file is a travel itinerary data file and said second data file is a travel supplier charge file.

13. The computer-readable medium of claim 1, wherein said billing statement comprises selected transaction information requested by said customer.

14. A method for booking and billing travel related transactions, the method comprising the steps of:
a) creating a travel request at a travel agent office;
b) transmitting a travel itinerary request to a travel supplier;
c) generating, at said travel supplier, a reference indicator in response to said travel itinerary request;
d) transmitting said reference indicator to said travel agent to confirm said travel itinerary request;
e) transmitting a travel itinerary data file, including said reference indicator, to a billing server;
f) generating a billing statement for a billing period based on said travel itinerary data file; and
g) sending said billing statement to a customer.

15. The method of claim 14, further comprising the steps of:
h) generating a travel supplier charge file, including said reference indicator, corresponding to said travel itinerary request;
i) transmitting said travel supplier charge file, including said reference indicator, to said billing server; and
j) reconciling said travel itinerary data file with said travel supplier charge file using said reference indicator.

16. The method of claim 15, further comprising the step of:
k) generating a revised billing statement if said travel itinerary data file with said travel supplier charge file are unmatched.
